(19) United States
(12) Patent Application Publication
(10) Pub. No.: US 2002/0128736 A1
(43) Pub. Date: Sep. 12, 2002

(54) Game machine

(76) Inventors: Hirotada Yoshida, Tokyo (JP); Takashi Otsuka, Tokyo (JP); Koji Yamaguchi, Tokyo (JP); Masanori Kimura, Tokyo (JP)

Correspondence Address: Faegre & Benson, 2200 Wells Fargo Center, 90 South Seventh Street, Minneapolis, MN, 55402-3901, US

(21) Appl. No.: 09/913,149

(22) PCT Filed: Dec. 8, 2000
(86) PCT No.: PCT/JP00/08699

(30) Foreign Application Priority Data
Dec. 10, 1998 (JP) HEI-11-351918

(51) Int. Cl. G06F 155/00

(52) U.S. Cl. 700/92

(57) ABSTRACT

[Object]

It is an object of the present invention to provide a game device in which the status of a plurality of games of players can be easily recognized when the results obtained by the players are displayed.

[Means for Solving the Problems]

A ranking display means for displaying the results of players on the basis of a ranking is provided. The ranking display means displays the status of a plurality of plays such as a display 34 of a new musical note, a display 35 of the degree of hardness or ease, a duet display 36 and a display 37 of an extra play, a display 38 of an expression of one's thanks for a full house, etc. as well as the ranking of the results.

### TECHNICAL FIELD

The present invention relates to a game device in which the superiority and inferiority of the merits of players are generated as a result of a game.

### BACKGROUND ART

Most of game devices have hitherto determined the results of players on the basis of the result of a game, the number of points obtained by them or time, etc., and fixed the rank of the players for the results of the game of the players in accordance with the determination. The game devices constituted as described above have been adapted to store the results of the players in a game memory part and admire the honor of a player who achieves good results and display a player whose results are most excellent so as to show a target for players who will play a game, Further, such a game device as to display a plurality of excellent players at the same time has displayed the players in the order of merits of them. In this case, when the results of the players are displayed, there appears not only a device for simply displaying the number of points obtained or time, but also a device for displaying the names of players of high rank or the nicknames of them and further a device for displaying the photographs of the faces of the players. For these game devices, a ranking display is one of important requirements to improve an operation rate.

In recent years, there have appeared many game devices in which a player can play a game after he or she freely selects types of games such as a game for one man, a game for a plurality of men, for instance, two men, the degree of hardness or ease, characters or vehicles or the like to be used. In some of the above described game devices, the ranking showing the order of results of the players has been displayed, however, it has not been disadvantageously understood as to which playing situation the players obtain the results only from the display of marks obtained or time. More specifically, there has not been clarified a situation as to which game of a game for one man and a game for a plurality of men the players who are displayed in the ranking play, what is the degree of hardness or ease, which of characters is used, and in which manner the players win a game, easily or by a shave, etc. Further, in the game device of a type that game elements such as characters or vehicles can be selected, the ranking in the selected game elements has been disadvantageously understood with difficulty.

Further, Japanese Patent Application Laid-Open No. Hei-9-10433 discloses a video game machine of a type that the progress of a round which a person who gets high marks plays is displayed in a video game machine for repeating the clearing of a round and a selection of a next round. However, the game machine disclosed in the Japanese Patent Application Laid-Open No. Hei-9-10433 displays only one information concerning the progress of a round and the contents of a play cannot be inconveniently understood. Further, all rounds are displayed in this video game machine, so that a large display area is undesirably required.

By considering the above described problems of the prior art, it is an object of the present invention to provide a game device in which the status of a plurality of games for players who get their results can be readily understood before the results are displayed.

### DISCLOSURE OF THE INVENTION

A game device according to the present invention having a ranking display means for displaying the ranking of players when the superiority or inferiority of players is generated in the results of the players as a consequence of a game, characterized in that the ranking display means is adapted to display information concerning the status of a plurality of plays as well as the ranking.

According to such a constitution, since the ranking display means for displaying the results of the players serves to display the status of a plurality of plays as well as the ranking, a user can readily know under which status of play the results ranked in the ranking are obtained.

Further, preferably, the information concerning the status of plays is information based on game elements selected by the players before the plays.

With such a constitution, the game elements selected by the player of good record can be readily understood.

Further, the information concerning the status of plays is desirably information based on game elements of a game for one man or a game for a plurality of men selected by the players before the plays.

According to the above described constitution, a user can easily understand whether the good result depends on a game for one man or a game for a plurality of men.

Still further, the information concerning the status of plays is effectively information based on game elements of the degree of hardness or ease in a game selected by the players before the plays.

According to the above described constitution, the degree of hardness or ease of the game when the good result can be obtained can be readily understood.

Still further, the information concerning the status of plays is preferably information based on an event generated during the play.

According to the above described constitution, the contents of the event generated during the play when the good result is got can be easily recognized.

Still further, the information concerning the status of plays is preferably displayed by symbols such as pictures or characters.

According to the above described constitution, since the status of each play displayed during the display of the ranking is represented by symbols in iconical forms, the status can be recognized at a glance.

Additionally, preferably, the symbols have the same size and forms and are displayed in parallel.

With such a constitution, the status of each play shown during the display of the ranking can be displayed in a regular manner and a space for display can be saved.

Furthermore, in a game device that the player selects a musical piece before the play, shows an instruction for performance based on the selected musical piece on a display, and operates an input and operating member in accordance with the instruction for performance so that the result of the player is determined depending on whether or not a timing between the instruction for performance and the operation of the input and operating member by the player is good, the ranking display means effectively displays the ranking, the marks obtained, the names of musical pieces, the dates of plays, and the names of players and the symbolized information concerning the status of a plurality of plays.

According to the above described constitution, the information that the players want to know during the display of the ranking in a music game can be substantially completely displayed.

### BRIEF DESCRIPTION OF THE DRAWINGS

FIG. 1 is a general perspective view showing one example of a game device according to the present invention.

FIG. 2 is a control block diagram of the game device.

FIG. 3 is an explanatory view showing an example on a display at the time of a game.

FIG. 4 is an explanatory view showing a display example in the first place in the ranking.

FIG. 5 is an explanatory view showing a display example of the ranking when game elements are selected.

### EMBODIMENT FOR CARRYING OUT THE INVENTION

Now, a preferred embodiment of the present invention will be described by referring to the drawings.

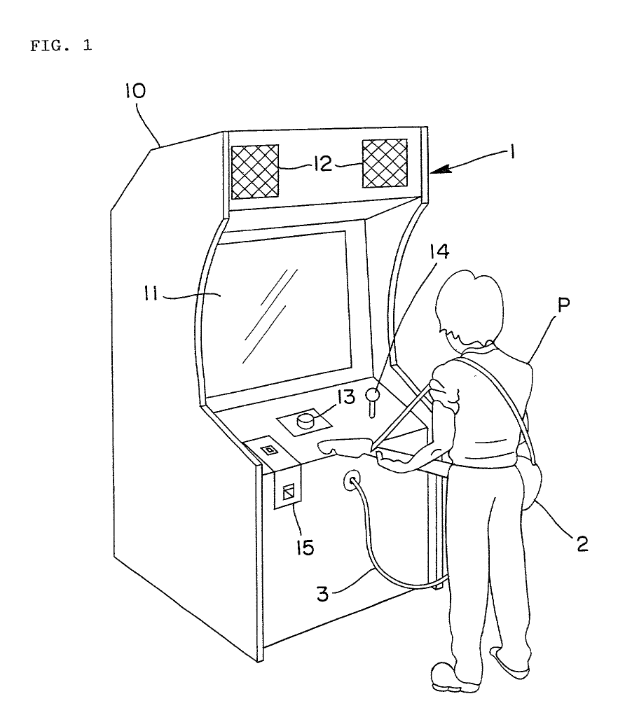

FIG. 1 is a perspective view showing one embodiment of a game device according to the present invention.

In FIG. 1, reference numeral 1 designates a device main body of a music game device. 2 denotes an input and operating member inputted and operated by a player P. The input and operating member 2 of this embodiment is a guitar type input member (called it a guitar input member 2, hereinafter) similar to an electronic guitar. In the music game device main body 1, a display 11, speakers 12, a game start button 13, a game selection lever 14, a coin device 15 and a control part 20 described below are provided in a casing 10. The guitar member 2 is connected to the device main body 1 through a cord 3.

In the music game device, the player P operates the guitar member 2 in accordance with an instruction displayed on the display 11 to generate the performed sound of the guitar to the performance of BGM (Background Music) of a selected musical piece supplied from the speakers 12.

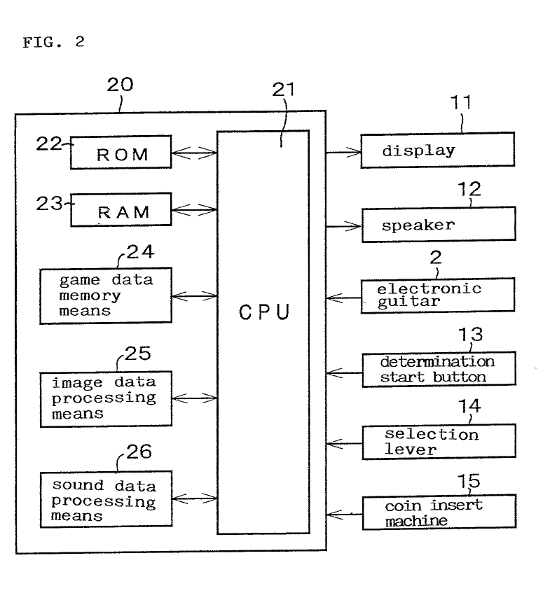

The control part 20 has a central processing unit (referred it to as a CPU 21, hereinafter), as shown in FIG. 2. To the CPU 21, are connected a ROM 22 in which a game program is stored, a RAM 23 in which play data or the like is written, a game data memory part 24 in which image data or data of musical pieces are stored, an image data processing means 25, and a sound data processing means 26. Further, the guitar member 2 is connected to the CPU 21 through an input interface (not shown). The CPU 21 sends the image data or the musical piece data or the like stored in the game data memory means 24 to the image data processing means 25 or the sound data processing means 26 in accordance with the game program stored in the ROM 22 to show a game screen on the display 11 and output BGM sound or guitar performance sound to the speakers 12.

In this control part 20, the game data memory part 24 can fetch data stored in a portable memory medium such as a CD-ROM, so that the game data memory part can store the data of new musical pieces at any time. Further, in the RAM 23, are stored a name or nickname inputted by the player, the date of a play, a selected musical piece, the result of a game, a game for one man or a game for a plurality of pesons, a game for two men in this embodiment, whether or not an extra play which is an event generated during the game and the player getting the set marks can enjoy is carried out, etc. In the present embodiment, the RAM 23 with a large memory capacity is employed so as to store innumerable play data therein.

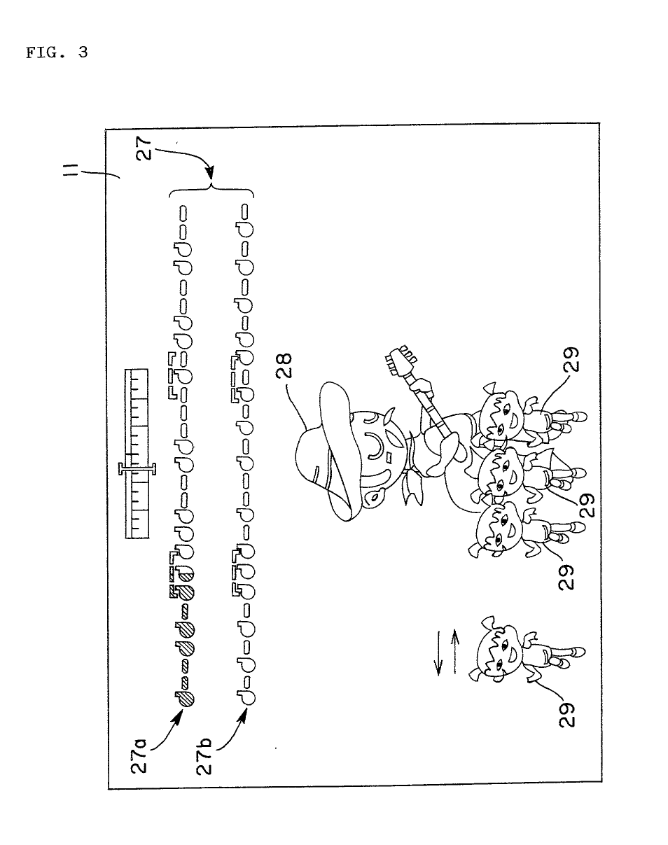

FIG. 3 shows one scene of a game displayed on the display 11 of the music game device of the present invention. In the upper part of the screen, scores 27 of two bars for a guitar performance by the player are displayed in two stages. In the two-bar scores 27, void musical notes are shown at positions corresponding to the part of the guitar, a colored instruction telop is adapted to flow from the left to the right of a two bar score 27a of an upper stage at a speed corresponding to the tempo of a music while the musical notes are filled with the telop, and then to flow from the left to the right of a two-bar score 27b of a lower stage. Then, as soon as the end of the instruction telop reaches a substantially intermediate part of the void musical notes, when the player operates the guitar member 2, the display of JUST appears on the musical notes and the guitar performance sound is generated from the speakers. In FIG. 3, reference numeral 28 designates a player character and 29 denotes characters increased or decreased in accordance with the elevation or lowering of a game level. When all the characters appear, a state of expression of one's thanks for a full house is obtained.

In this game device, it is judged whether or not the operating timing of the player is good. Thus, the result of the game is determined based on the judgement. In parts before and after the JUST area, areas of OK are provided and areas outside the OK areas are set to MISS areas. As a scoring method, either a merit mark method or a demerit mark method can be employed. In the present embodiment, when an operation is carried out in the JUST area, a score 2 can be got. In the OK areas, the merit mark or the demerit mark is not got. When the operation of the guitar member is carried out in the MISS areas so that the operation of the guitar is not performed in the JUST area and the OK areas, a score −1 is given.

In such a manner, the results of the plays of the players are determined in accordance with the above mentioned scoring method. When the player gets a preset result or higher than it, the display of a game entry appears to record the name or nickname of the player which is stored in the RAM 23 together with the result. In this connection, the names or the like may be recorded before the start of the game. Then, also in the game device of the present invention, for example, the best ten of excellent players having good records or the like may be counted down and displayed on the display 11 during an attraction mode in which the play is not carried out.

The game device of the present invention includes the game data of several hundred musical pieces, so that the degree of hardness or ease of game is different for each of the musical pieces. Therefore, even when players with equal skill play the guitar, there may completely possibly arise great differences in score depending on selected musical pieces. Further, in the game device of the present invention, when the game played by a plurality of men is selected, the result of the game is judged on the basis of the average mark of the marks of a plurality of men. Accordingly, in such a game device, when the ranking of the players determined and arranged in the order of high marks is displayed, it is substantially no sense to simply display the names and marks of the players.

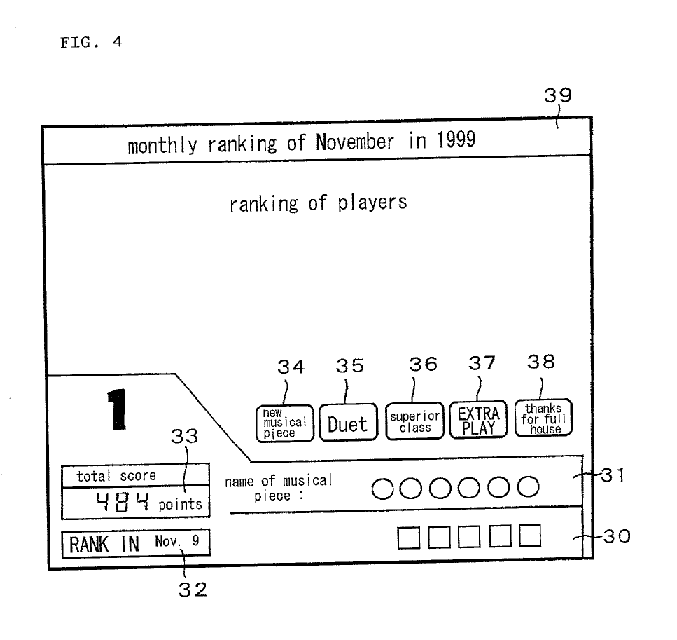

Thus, according to the present embodiment, as shown in FIG. 4, a plurality of status of plays are displayed on a ranking display screen in addition to the respective displays of the name 30 of a player, a musical piece 31 of a play, the date 32 of a play, and the marks 33 obtained. The status of plays includes a new musical piece symbol 34 for understanding a new musical piece as the information of a played music piece, a symbol 35 showing the degree of hardness or ease for understanding which class of a superior class, an average class and a beginner's class the play of the player belongs to, when the degree of hardness or ease is classified into the superior class, the average class and the beginner's class, a duet symbol 36 for understanding the contents of a play such as a play for one man or a play for two men, an extra play symbol 37 for understanding that a play reaches an extra play and a symbol 38 showing an expression of one's thanks for a full house for understanding the expression of one's thanks for a full house which is displayed when the level of the player reaches near to the highest level at the end of the game.

In the above described new musical piece symbol 34, musical pieces produced within a period set from the date on which the data is stored in the data memory part 24 are considered to be new musical pieces, and when the player plays the guitar member to the above musical pieces, the new musical piece symbol 34 is displayed. Therefore, when the player plays the guitar member to other musical pieces than the new musical pieces, the new musical piece symbol 34 is not displayed, so that it can be understood at a glance whether or not the player plays the guitar member to the new musical piece. The above described symbol 35 showing the degree of hardness or ease displays the symbol 35 showing the “superior class” only when the player plays the guitar member to the musical piece of the superior class. When the player plays the guitar member to the musical pieces of the “average class” and the “beginner's class”, the symbols 35 showing the degree of hardness or ease which represent the “average class” and the “beginner's class” may be displayed. The duet symbol 36 only displays a play for two men. Therefore, when the duet signal 36 is not displayed, it is understood that the player plays a game for one man. The extra play symbol 37 or the symbol 38 showing the expression of one's thanks for a full house indicate events generated when some conditions are cleared during the game and only the players for whom such events are generated are displayed.

Thus, according to the present invention, the respective symbols showing a plurality of status in a game are displayed in iconical forms, and the respective symbols are formed in the same size and the same configuration, so that much information can be displayed in a small space. Further, if the respective symbols are arranged in parallel as illustrated in FIG. 4, they can be displayed in a regular manner and readily seen and recognized. In this case, all the symbols shown in the conical forms are based on characters. However, “Duet” indicating the play for a plurality of men may be a symbol of a designed picture having a plurality of persons. Further, in FIG. 4, reference numeral 39 designates a telop display part for displaying information, such as “a monthly ranking during November in 1999” by the telop.

As described above, when the ranking of the players is displayed, not only the marks obtained, but also a plurality of status in a game are displayed, so that a user can readily understand under which status the marks obtained by the displayed player are got. Since each status of play is displayed by the symbol shown in an conical form, a plurality of status can be easily recognized and displayed by saving a space.

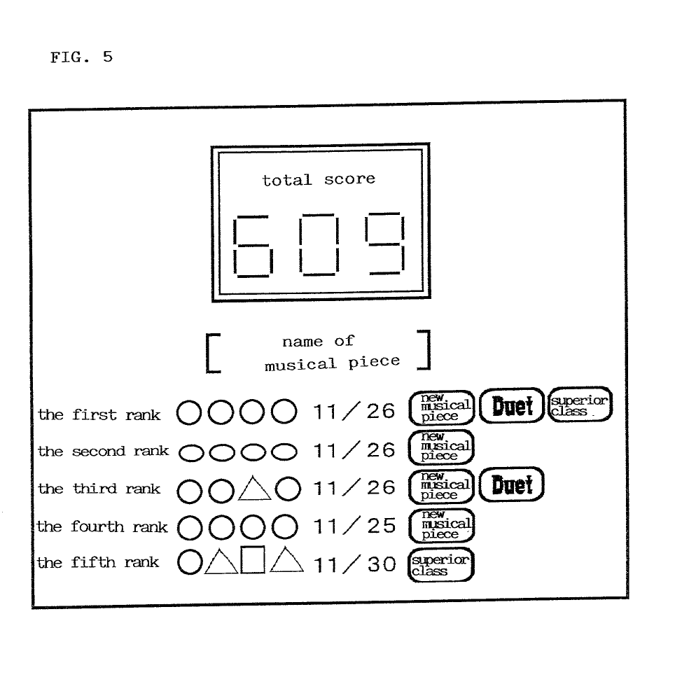

In the above described music game device, the player can freely select a musical piece before the play. In other words, if the musical pieces are considered as game elements, the player can select one from among many game elements and play the guitar to the selected one. Then, when the player selects the musical piece and/or completes his plays, the ranking of players in the selected musical piece is displayed. FIG. 5 shows one example of this display.

If the ranking is displayed before a game, information for marks desired by a player can be obtained. If the ranking is displayed after the play, information concerning the rank of the player himself or his skill can be obtained. In the display of the ranking, if the status display such as the name 30 of a player, the new musical piece symbol 34, the symbol 35 showing the degree of hardness or ease, the duet symbol 36 or the like is displayed by icons, as shown in FIG. 5, the status of the game when the marks are obtained by the player can be readily understood.

Although the preferred embodiment of the present invention is described above, it is to be understood that the present invention is not limited to the above described embodiment and various kinds of modifications may be performed.

For instance, although the above described embodiment is applied to an example of the music game device, the invention may be applied to any game such as a racing game, a grappling game, a fishing game, a shooting game and further, a baseball or a soccer game, etc. in which the superiority or inferiority is generated as the result of a game irrespective of the contents thereof. For example, in the racing game, is preferably displayed the status of a game such as a machine and its transmission to be used which are selected by a player before a play, a course to be used and the number of times of crashes as events generated during the game as well as the ranking. Further, in the grappling game, there is preferably displayed the status of a game such as characters to be used, a winning performance, the number of times of knock outs, the contents of the characters whom the player defeats as well as the ranking. Further, in the grappling game and a professional wrestling game, there is preferably displayed information concerning a single match or a tug match as a game played by one man or a tug match as a game played by a plurality of persons. In the fishing game, there is preferably displayed the status of a play such as a fishing place, a trick, etc. In the shooting game, the rate of hitting the mark and the number of times of receiving attacks from an enemy are preferably displayed. In the baseball game, there is preferably displayed the status of a game such as a baseball ground to be used, the number of home runs, the number of getting strike-outs. In the soccer game, there is preferably displayed the status of a game such as a soccer ground to be used, the weather and the number of shoots, respectively.

1. A game device having a ranking display means for displaying the ranking of players when the superiority or inferiority of players is generated in the results of the players as a consequence of a game, characterized in that said ranking display means is adapted to display information concerning the status of a plurality of plays as well as the ranking.

2. A game device according to claim 1, characterized in that the information concerning the status of plays is information based on game elements selected by the players before the plays.

3. A game device according to claim 1 or 2, characterized in that the information concerning the status of plays is information based on game elements of a game for one man or a game for a plurality of men selected by the players before the plays.

4. A game device according to claim 1 or 2, characterized in that the information concerning the status of plays is information based on game elements of the degree of hardness or ease in a game selected by the players before the plays.

5. A game device according to claim 1, characterized in that the information concerning the status of plays is information based on an event generated during the play.

6. A game device according to any one of claims 1 to 5, characterized in that the information concerning the status of plays is displayed by symbols such as pictures or characters.

7. A game device according to claim 6, characterized in that said symbols have the same size and forms and are displayed in parallel.

8. A game device according to any one of claims 1 to 7 in which the player selects a musical piece before the play, shows an instruction for performance based on the selected musical piece on a display, and operates an input and operating member in accordance with the instruction for performance so that the result of the player is determined depending on whether or not a timing between the instruction for performance and the operation of the input and operating member by the player is good, characterized in that said ranking display means displays the ranking, the marks obtained, the names of musical pieces, the dates of plays, and the names of players and the symbolized information concerning the status of a plurality of plays.
